(19) United States
(12) Patent Application Publication
(10) Pub. No.: US 2015/0077550 A1
(43) Pub. Date: Mar. 19, 2015

(54) SENSOR AND DATA FUSION

(71) Applicant: Star Management Services, LLC, New York, NY (US)

(72) Inventors: Yaacov APELBAUM, Sayville, NY (US); Oleg Ruchovetz, Netanya (IL); Guy Lorman, Kfar Saba (IL); Shay Azulay, Rishon Le Zion (IL); Ofer Sofer, Netanya (IL); Shiva Karthikeyan Rathinam Thangavelu, Tamil Nadu (IN)

(73) Assignee: Star Management Services, LLC, New York, NY (US)

(21) Appl. No.: 14/028,642

(22) Filed: Sep. 17, 2013

(51) Int. Cl. H04N 7/18; G06N 99/00

(52) U.S. Cl. CPC H04N 7/181; G06N 99/005
USPC 348/143

(57) ABSTRACT

A surveillance method includes incorporating competitive sensor fusion with complementary sensor fusion in detection of events by a plurality of sensor networks.

### FIELD OF THE DISCLOSURE

The present disclosure relates to sensor fusion.

### BACKGROUND

Surveillance systems are widely used worldwide, aiming at monitoring public areas, restricted areas and private properties.

Surveillance refers to a vast variety of monitoring activities, which may include for example, viewing designated areas by cameras (e.g., CCTV cameras, IR cameras, etc.), intercepting electronically transmitted information, recording speech and sounds, monitoring physical properties (e.g., temperature, humidity, conductivity, etc.), and so on.

Surveillance activities may include, for example, computer surveillance monitoring electronic activity of a single computer, computer networks, such as the Internet, including, inter-alia, web traffic, instant messaging services, etc., communication devices (telephones, mobile phones, communication networks), social network analysis (monitoring of messages and information), biometric monitoring (e.g., fingerprints, voice recognition, face recognition, etc.), hybrid knowledge based expert system (data mining, rule based system, fuzzy-neuro system, neuro-fuzzy system, etc.) and profiling aimed at discovering behavioural patterns, unusual or unlawful behaviour, detecting criminal intentions and perpetration, identification, authentication and authorization of subjects requesting access to restricted sites or requesting confirmation to perform a restricted action.

### SUMMARY

There is thus provided, in accordance with some embodiments of the present invention, a surveillance method including incorporating competitive sensor fusion with complementary sensor fusion in detection of events by a plurality of sensor networks.

Furthermore, in accordance with some embodiments of the present invention, the method further includes incorporating cooperative sensor fusion in the detection of the events.

Furthermore, in accordance with some embodiments of the present invention, the method further includes incorporating data fusion from one or a plurality of data resources in the detection of the events.

Furthermore, in accordance with some embodiments of the present invention, the method further includes receiving detection classification from a human operator.

Furthermore, in accordance with some embodiments of the present invention, the method further includes receiving detection classification from a hybrid knowledge-based expert system.

Furthermore, in accordance with some embodiments of the present invention, the hybrid knowledge-based expert system includes automated machine learning capability.

Furthermore, in accordance with some embodiments of the present invention, the method further includes scoring a sensor by a sensor scoring system.

Furthermore, in accordance with some embodiments of the present invention, the sensor networks include sensors that are selected from the group of sensors consisting of: CCTV camera, IR camera, PTZ camera, face recognition camera, acoustic sensor, license plate reader, retinal scanner, fingerprint reader and biometric sensor.

There is further provided, in accordance with some embodiments of the present invention, a non-transitory computer readable storage medium having stored thereon instructions that when executed by a processor will cause the processor to incorporate competitive sensor fusion with complementary sensor fusion in detection of events by a plurality of sensor networks.

Furthermore, in accordance with some embodiments of the present invention, the instructions are further configured to cause the processor to incorporate cooperative sensor fusion in the detection of the events.

Furthermore, in accordance with some embodiments of the present invention, the instructions are configured to cause the processor to further incorporate data fusion from one or a plurality of data resources in the detection of the events.

Furthermore, in accordance with some embodiments of the present invention, the instructions are further configured to cause the processor to receive detection classification from a human operator.

Furthermore, in accordance with some embodiments of the present invention, the sensor networks include sensors that are selected from the group of sensors consisting of: CCTV camera, IR camera, PTZ camera, face recognition camera, acoustic sensor, license plate reader, retinal scanner, fingerprint reader and biometric sensor.

Furthermore, in accordance with some embodiments of the present invention, the instructions are further configured to receive detection classification from a hybrid knowledge-based expert system, the hybrid knowledge-based expert system comprising automated machine learning capability.

Furthermore, in accordance with some embodiments of the present invention, the instructions are further configured to score a sensor by a sensor scoring system.

There is further provided, in accordance with some embodiments of the present invention, a system including: a processor, the processor configured to incorporate competitive sensor fusion with complementary sensor fusion in detection of events by a plurality of sensor networks.

Furthermore, in accordance with some embodiments of the present invention, the processor is further configured to incorporate cooperative sensor fusion in the detection of the events.

Furthermore, in accordance with some embodiments of the present invention, the processor is further configured to incorporate data fusion from one or a plurality of data resources in the detection of the events.

Furthermore, in accordance with some embodiments of the present invention, the processor is further configured to receive detection classification from a human operator.

Furthermore, in accordance with some embodiments of the present invention, the system further comprises one or a plurality of the sensor networks.

Furthermore, in accordance with some embodiments of the present invention, the sensor networks include sensors that are selected from the group of sensors consisting of: CCTV camera, IR camera, PTZ camera, face recognition camera, acoustic sensor, license plate reader, retinal scanner, fingerprint reader and biometric sensor.

Furthermore, in accordance with some embodiments of the present invention, the processor is further configured to receive detection classification from a hybrid knowledge-based expert system, the hybrid knowledge-based expert system comprising automated machine learning capability.

Furthermore, in accordance with some embodiments of the present invention, the processor is further configured to score a sensor by a sensor scoring system.

### BRIEF DESCRIPTION OF THE DRAWINGS

FIG. 1 illustrates a surveillance system, in accordance with some embodiments of the present invention.

FIG. 2 illustrates a remote surveillance center, in accordance with some embodiments of the present invention.

FIG. 3 illustrates a classification process of sensor fusion, according to some embodiments of the present invention.

FIG. 4 illustrates a processing unit for a surveillance system, according to some embodiments of the present invention.

### DETAILED DESCRIPTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

“Subject”, in the context of the present specification refers, inter-alia, to any person, animal, object, event or action, which is to be monitored, tracked, detected, and/or identified.

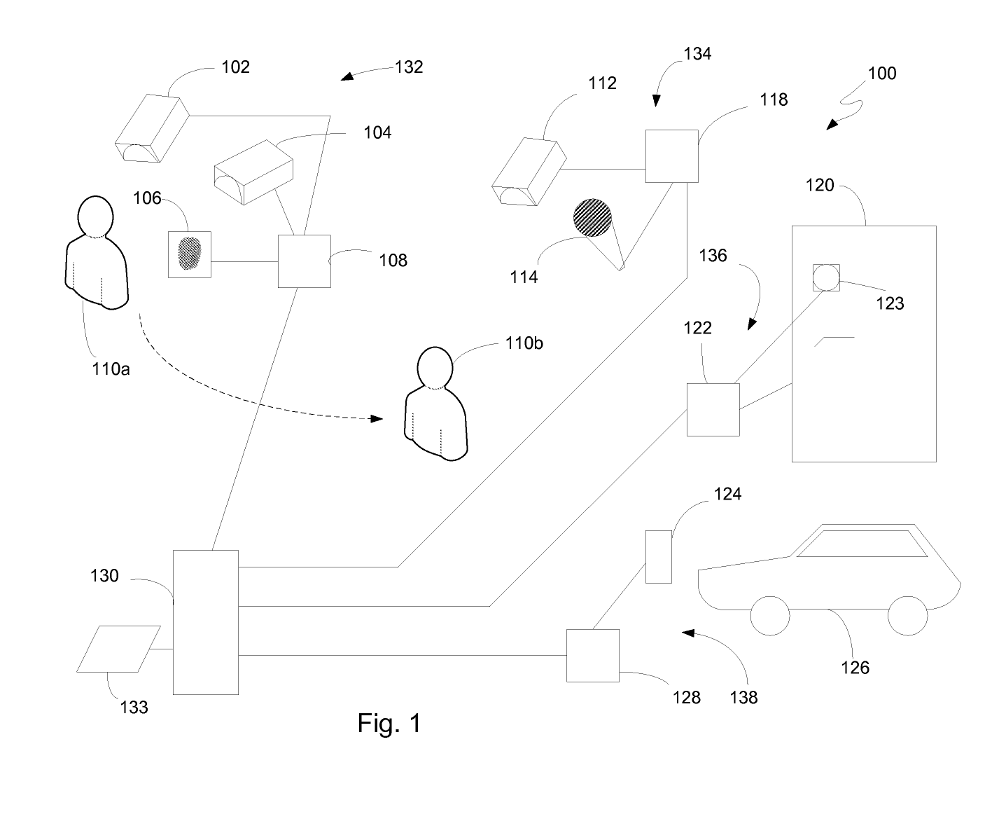

FIG. 1 illustrates a surveillance system 100, in accordance with some embodiments of the present invention.

In the example depicted in FIG. 1, system 100 incorporates four sensor networks, 132, 134, 136 and 138. Sensor network 132 a CCTV cameras 102 and 104, and a fingerprint reader device 106, connected to network control 108. Sensor network 134 includes a CCTV camera 112 and an acoustic sensor 114 (e.g., microphone) connected to network control 118. Sensor network 136 includes a retinal scanner 123 coupled to a door 120 for monitoring access through that door, connected to network control 122. Sensor network 138 includes a license plate reader (LPR) 124 connected to network control 128. All network controls (108, 118, 122 and 128) are connected to remote surveillance center 130. Remote surveillance center may be all automated or involve one or a plurality of devices operated automatically and/or one or a plurality of human assisted devices.

Sensor networks, in accordance with some embodiments of the present invention may include a variety of sensors, such as, for example, CCTV camera, IR camera, Face recognition camera, PTZ (pan, tilt, zoom) camera, acoustic sensor, license plate reader, retinal scanner, fingerprint reader and biometric sensor.

The reliability and accuracy of a surveillance system is an important issue. In principle, the more information is gathered the greater the reliability and accuracy of the surveillance system is.

In employing several sensors to acquire independent sensed data of the same characteristic of the object (hereinafter—competitive sensor fusion), the sensed data from each independent source improves the overall reliability of the detection level of the surveillance system. Competitive fusion may contribute to improving fault-tolerance of the surveillance.

For example, in sensor network 132 the two CCTV cameras 102 and 104 are used to independently acquire images of a subject 110a located in the field of view (or line-of-sight) of the cameras for face recognition. The image data acquired by CCTV camera 102 may be used, for example for face recognition based on face geometry characteristics, whereas the image data acquired by CCTV camera 104 may be used for face recognition which is based on the position and relation of the subject's pupils. Competitive sensor fusion of sensor data may help reduce noise and false-positive detections, facilitating a more reliable detection.

The subject may be required to hold a finger on a fingertip reader 106, so as to provide another independent data—biometric data in this case—to serve as complementary data to the face recognition data obtained by the CCTV cameras 102 and 104. Combining different detection techniques (face recognition and biometric recognition) using data sensed in the same monitored area by different sensors and employing different detection techniques (hereinafter—complementary sensor fusion) allows for a more complete detection and identification of the subject. The complementary sensor fusion in this case may be performed by network controller 108 that analyzes the sensed data forwarded to it, or that incorporates detection data received from the different sensor networks 132 and 134.

Further fusion of sensed data may be performed by combining sensed data obtained from different sensor networks, monitoring different areas of interest, for example, by obtaining sensed data from CCTV cameras 102 and 104 and/or fingertip reader 106 and on sensed data obtained from CCTV camera 112 and microphone 114. The fusion in this case may be performed by remote surveillance center 130, which is in communication with network controls 108 and 118. Such sensed data fusion is referred to hereinafter as cooperative sensor fusion. For example, in cooperative sensor fusion, it is possible to combine LPR 124 detection by sensor network 138 with an acoustic detection of a gun-shot by acoustic sensor 114 of sensor network 134, to detect and identify a drive-by shooting event.

Similarly, cooperative sensor fusion may be performed by obtaining sensed data from retinal scanner 123 and/or from LPR 124 via network controls 122 and 128 (respectively). In fact any combination of sensors may be considered for performing detection based on complementary sensor fusion.

A lot of complementary information may be derived from combining sensed data from sensors networks that monitor different areas of interest. For example, sensor network 132 may be monitoring one area of interest whereas sensor network 134 may monitor another area of interest. There areas of interest may be adjacent areas (e.g., two adjacent stretches of a pavement), close-by areas (e.g., opposite sides of a building, a store and a nearby warehouse) or even remote areas (e.g., banking facilities in different parts of town, or in different towns). A-priory knowledge of the distance between the areas of interest monitored may be used and taken into account when analyzing sensed data received from the different sensor networks.

In one example, a vehicle 126 may approach a checkpoint where sensor network 138 with LPR 124 is located. Sensor network 138 verifies the right of that vehicle to enter a restricted one upon which the vehicle is allowed to pass the checkpoint. A few minutes later sensor network 136 with retinal scanner 123 verifies the identity of a person who is authorized to enter through door 120. Sensor network 136 and sensor network 138 may share their sensed data in complementary sensor fusion (e.g. via network controls 122 and 128 to remote surveillance center 130) to further substantiate the person's identity and right to pass that door.

Considering another example, subject 110a may first be spotted, identified and monitored in n area of interest covered by sensor network 132. At a later time the same subject (subject now indicated by 110b) may appear in another area of interest monitored by sensor network 134. In determining the subject's detection and identification, the difference in times of detection (the time difference between the first detection in the area monitored by sensor network 132 and the second detection in the area monitored by sensor network 134) may also be taken into consideration. Such consideration may involve, for example, determining the speed at which subject 110a is crossing the area monitored by sensor network 132 and relating that speed to the distance between the two monitored areas. At a given speed the arrival of subject 110b to the area monitored by sensor network 134 can be narrowed to a time range, and the subject's arrival within that time range may serve to further validate the detection and identification of subject 110b in the area monitored by sensor network 134.

Considering sensed data from different sensor networks that monitor different areas may be helpful in extracting patterns and trends.

Further information may be incorporated, for example, by referring to additional information which may be provided, for example, in the form of domain databases (e.g., relating to a database maintained by particular organization or type of subject matter, for example, a motor vehicle department, or a database related to immigration or telephones). Information relating to subjects identified by a surveillance system according to some embodiments of the present invention may be enriched by incorporating additional information sources to achieve a fuller situational awareness picture. An example of such data fusion may be the assessment and correlation of an event related to sensed data by LPR 124, acoustic sensor 114, a DMV (Department of Motor Vehicles) database, that includes information on licensed vehicles and their owners, and a black-list data base, that includes a list of known criminals, to identify perpetrators of a drive-by shooting incident.

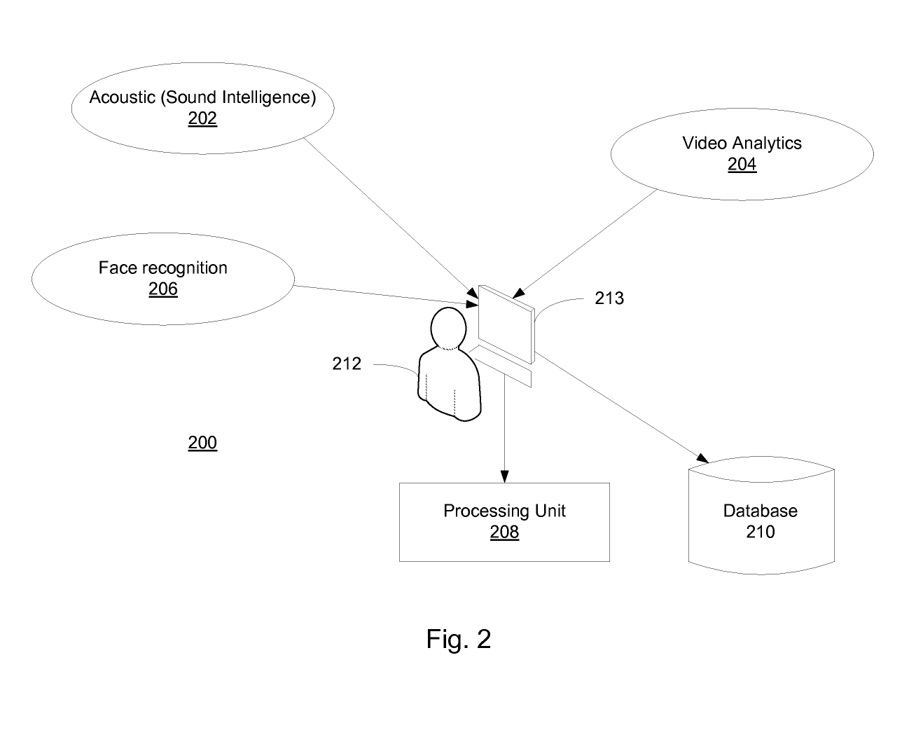

FIG. 2 illustrates a remote surveillance center 200, in accordance with some embodiments of the present invention. Remote surveillance center 200 may include a manned station 213, which is manned by a human operator 212.

Detections from various sensor networks may arrive at station 213, e.g., acoustic detection 202 from an acoustic sensor network, video analytics 204 from a video sensor network, face recognition detection 206, from a face recognition sensor network, etc.

The human operator 212 may validate the detections, by considering each of the automated detections. The human operator 212 may accept the detection, reject the detection, mark it as nuisance or mark it as inconclusive. The validated detections may be then saved in a database 210 and/or undergo further processing by processing unit 208.

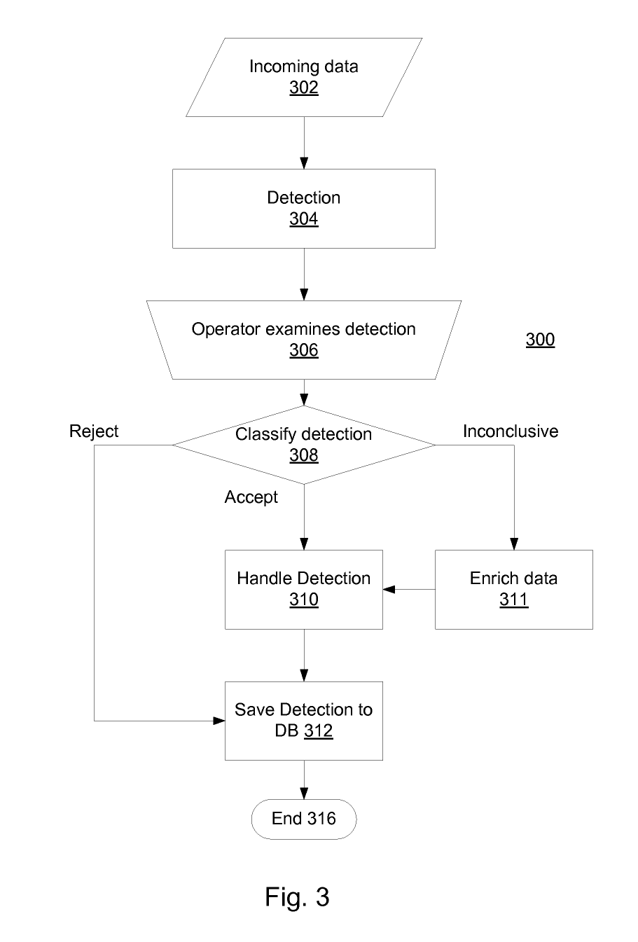

FIG. 3 illustrates a classification process 300 of sensor fusion, according to some embodiments of the present invention.

The process starts with an incoming sensed data 302, which may be acquired by one or a plurality of sensors of a sensor network. Upon detection 304 (e.g., an automated detection, for example, based on automatically comparing the sensed data to a threshold or to a look-up table, etc.), the human operator (e.g., a classifier operator) may be alerted and examines 306 the detection and classifies 308 it by providing detection grading in the form of “accepted”, “rejected”, “nuisance” or “inconclusive”. The grading “nuisance” is a valid detection but it is not logical (for example, a police car parked in the illegal parking area).

If “accepted” the operator handles 310 the detection according to operational instructions or manual (e.g., reports the detection, signals the detection, or performs some other action), and the detection is saved 312 in a detection database, for future reference.

If classified as “inconclusive”, the operator may look for additional enriching data (e.g., wanted list of criminals, list of stolen cars, etc.) to help in finalizing the handling 310. The detection is saved 312 in the database for future reference.

If “rejected” the detection is merely saved 312 in the database for future reference.

The process ends 316 after saving the detection in the database for future reference.

Saved information associated with a specific sensor may include one or a plurality of the following items: data relating to a variety of parameters. For example, the saved detection data may include data on the total number of detections of a sensor over a predetermined period of time, total number of false detections over a predetermined period of time, the priority rating relating to the sensor, rating based on time of day, season and specific periods of times, rating based on holidays and special events, relationships to other sensors, next best sensor graph, GPS and data time stamp associated with the detection, detection rate (e.g., per second, minute, hour, etc.), minimal and maximal limit ranges (e.g., LPR speed limit for facilitating detection is 0-200 Km/hour), minimal and maximal number of detections per a specific period of time (e.g., maximal number of LPR detections per day at a given checkpoint).

Saved information associated with the surveillance system may include one or a plurality of items from the following items: grading of the human operator (e.g., grading the classifier), Historical data relating to previous successful fusion (e.g., per sensor), general history of critical events.

The following considerations may be applied in some embodiments of the present invention, in the processing and analyzing of the sensed data, in order to save computing resources.

In some embodiments of the present invention one or a plurality of sensors would be prioritized over (e.g., a sensed event by that sensor would be presented to an user prior to) other sensors of the surveillance system. For example, CCTV camera monitoring a restricted area would be prioritized over CCTV camera watching a shopping center.

In processing and analyzing sensed data time, season, specific periods, would be considered. For example, there would be no need for face detection at a shopping center entrance, if that shopping center is closed due to a holiday.

Sensor relationship would be considered. For example, an access control sensor at a checkpoint is related to a face detection camera stationed overlooking that checkpoint. Relationship types may include geographical location, indoor/outdoor, proximity distance of the sensor, common field of view (FOV), graphical relationship representing distance of the sensor, time, direction, geographical location, etc.

In order to reduce the number of false positive or false negative events (reducing the false events while maintaining high detection rates) sensors of the surveillance system, in accordance with some embodiments of the present invention would be subjected to one or a plurality of filters. For example, a sensor may be limited to a predefined range of number of detection (e.g., per a given period of time). A human filter (classifier) may be used to verify detections.

In order to reduce the number of false positive or false negative events for a sensor or plurality of sensors, a surveillance system, in accordance with some embodiments of the present invention, may perform scoring of the sensors based on the sensor scoring system. Sensor scoring system in processing and analyzing may consider sensor category, sensor purpose, sensor usage, sensor relationship based on the detection of the events by competitive fusion, complimentary fusion, cooperative fusion, data fusion and/or plurality of fusion, season, time, spatio-temporal relationship, geographical information, weather information, indoor/outdoor, illumination of the sensor or plurality of sensors, direction, angle, proximity radius, distance, and/or field of view (FOV).

In order to reduce the number of false positive or false negative events sensors, a surveillance system, in accordance with some embodiments of the present invention, may include a hybrid knowledge-based expert system. The hybrid knowledge-based expert system would classify the detection using one or plurality of artificial intelligence techniques. Classification is the decision surface in the pattern space. Classification may also consider a shortest path in the decision tree. Artificial intelligence techniques in the hybrid knowledge-based expert system may be rule based system, data mining techniques, fuzzy system, fuzzy-neuro system, neuro-fuzzy system, neural network architectures with appropriate algorithms, and/or automated classifier modelling system etc.,

The hybrid knowledge-based expert system performs the noise elimination for the sensed data. For example, noise could be eliminated by techniques such as binning, clustering, smoothing, Principal Component Analysis (PCA), and or Replicator Neural Networks (RNN). Unwanted redundancy in the sensed data is removed, for example, by performing correlation analysis etc. Outlier, anomaly and/or skewness detection/analysis may be performed to improve the accuracy of the hybrid knowledge-based expert system in a model that could be built.

The hybrid knowledge-based expert system may include automated machine learning capability using the classification by the classifier in continuous increment, or without using the classifier's classification in continuous increment. Machine learning capability may include statistical learning, artificial intelligence-based learning, neural network learning, and/or genetic learning, which can be either supervised or unsupervised. For example, supervised learning assumes the availability of a supervisor who classifies the data into classes, whereas unsupervised learning does not assume the availability of a supervisor for the classification.

“Detection” with respect to a surveillance system according to some embodiments of the present invention may relate to an instantaneous event (e.g., a license plate reader detecting a license plate of a vehicle at a checkpoint) or to a detection of a continuous event (e.g., the driving time and average speed of a vehicle moving between two monitored areas).

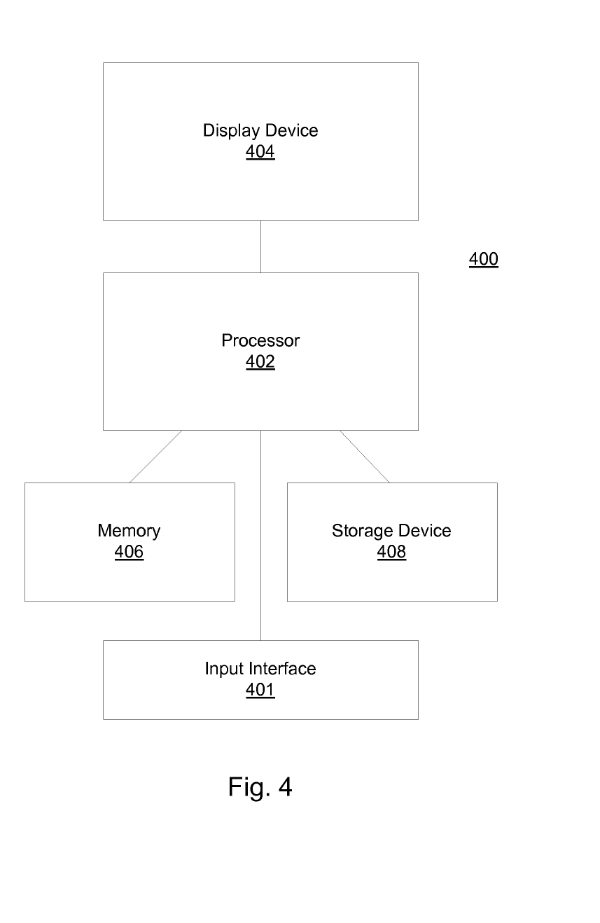

FIG. 4 illustrates a processing unit 400 for a surveillance system, according to some embodiments of the present invention.

Processing unit 400 may include a processor 402 (e.g. one or a plurality of processors, on a single machine or distributed on a plurality of machines, or a multi-core processor). Processor 402 may be linked with memory 406 on which a program implementing a method according to some embodiments of the present invention and corresponding data may be loaded and run from, and storage device 408, which includes a non-transitory computer readable medium (or mediums) such as, for example, one or a plurality of hard disks, flash memory devices, etc. on which data (e.g. dynamic object information, values of fields, etc.) and a program implementing a method according to examples and corresponding data may be stored. Processing unit 400 may further include display device 404 (e.g. CRT, LCD, LED, OLED, etc.) on which one or a plurality user interfaces associated with a program implementing a method according to examples and corresponding data may be presented. Processing unit 400 may also include input device 401, such as, for example, one or a plurality of keyboards, pointing devices, touch sensitive surfaces (e.g. touch sensitive screens), etc. for allowing a user to input commands and data.

Some embodiments may be embodied in the form of a system, a method or a computer program product. Similarly, examples may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Some embodiments are described hereinabove with reference to flowcharts and/or block diagrams depicting methods, systems and computer program products according to various embodiments.

Features of various embodiments discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure.

We claim:

1. A surveillance method comprising incorporating competitive sensor fusion with complementary sensor fusion in detection of events by a plurality of sensor networks.

2. The method of claim 1, further comprising incorporating cooperative sensor fusion in the detection of the events.

3. The method of claim 2, further comprising incorporating data fusion from one or a plurality of data resources in the detection of the events.

4. The method of claim 1, further comprising receiving detection classification from a human operator.

5. The method of claim 1, further comprising receiving detection classification from a hybrid knowledge-based expert system.

6. The method of claim 5, wherein the hybrid knowledge-based expert system comprises automated machine learning capability.

7. The method of claim 1, further comprising scoring a sensor by a sensor scoring system.

8. The method of claim 1, wherein the sensor networks include sensors that are selected from the group of sensors consisting of: CCTV camera, IR camera, PTZ camera, face recognition camera, acoustic sensor, license plate reader, retinal scanner, fingerprint reader and biometric sensor.

9. A non-transitory computer readable storage medium having stored thereon instructions that when executed by a processor will cause the processor to incorporate competitive sensor fusion with complementary sensor fusion in detection of events by a plurality of sensor networks.

10. The non-transitory computer readable storage medium of claim 9, the instructions further configured to cause the processor to incorporate cooperative sensor fusion in the detection of the events.

11. The non-transitory computer readable storage medium of claim 9, the instructions configured to cause the processor to further incorporate data fusion from one or a plurality of data resources in the detection of the events.

12. The non-transitory computer readable storage medium of claim 9, wherein the instructions are further configured to cause the processor to receive detection classification from a human operator.

13. The non-transitory computer readable storage medium of claim 9, wherein the sensor networks include sensors that are selected from the group of sensors consisting of: CCTV camera, IR camera, PTZ camera, face recognition camera, acoustic sensor, license plate reader, retinal scanner, fingerprint reader and biometric sensor.

14. The non-transitory computer readable storage medium of claim 9, the instructions further configured to receive detection classification from a hybrid knowledge-based expert system, the hybrid knowledge-based expert system comprising automated machine learning capability.

15. The non-transitory computer readable storage medium of claim 9, the instructions further configured to score a sensor by a sensor scoring system.

16. A system comprising:
a processor, the processor configured to incorporate competitive sensor fusion with complementary sensor fusion in detection of events by a plurality of sensor networks.

17. The system of claim 16, wherein the processor is further configured to incorporate cooperative sensor fusion in the detection of the events.

18. The system of claim 17, wherein the processor is further configured to incorporate data fusion from one or a plurality of data resources in the detection of the events.

19. The system of claim 16, wherein the processor is further configured to receive detection classification from a human operator.

20. The system of claim 16, further comprising one or a plurality of the sensor networks.

21. The system of claim 20, wherein the sensor networks include sensors that are selected from the group of sensors consisting of: CCTV camera, IR camera, PTZ camera, face recognition camera, acoustic sensor, license plate reader, retinal scanner, fingerprint reader and biometric sensor.

22. The system of claim 16, wherein the processor is further configured to receive detection classification from a hybrid knowledge-based expert system, the hybrid knowledge-based expert system comprising automated machine learning capability.

23. The system of claim 16, wherein the processor is further configured to score a sensor by a sensor scoring system.
